(19) United States
(12) Patent Application Publication
(10) Pub. No.: US 2007/0187128 A1
(43) Pub. Date: Aug. 16, 2007

(54) POWER SUPPLY ADAPTER OF VENTILATION DEVICE

(75) Inventor: ZHENG-HENG SUN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,427

(22) Filed: Aug. 4, 2006

(30) Foreign Application Priority Data
Feb. 15, 2006 (CN) 200610033724.1

(51) Int. Cl. H01R 13/46; H01R 9/05; F24F 7/06; H02G 3/18; H01R 4/02

(52) U.S. Cl. 174/60; 454/338; 174/74 R; 439/874

(57) ABSTRACT

A power supply adapter is provided to transform a power supply interface of a ventilation device. The ventilation device includes a plug. The power supply adapter includes a main body. The main body includes a mounting element for mounting the ventilation device, a first power supply interface for electrically connecting with the plug of the ventilation device, and a second power supply interface. The second power supply interface is for connecting with an external power supply. The first power supply interface is electrically connected to the second power supply interface.

### FIELD OF THE INVENTION

The present invention relates to adapters, and particularly to a power supply adapter of ventilation devices.

### DESCRIPTION OF RELATED ART

When testing an electrical product such as a motherboard, components on the motherboard may produce heat that needs to be dissipated, thereby increasing test veracity. A conventional method for dissipating the heat is to provide a ventilation device such as a fan or a blower, aimed at the motherboard under testing. Typically, the ventilation device is powered via a plug of the ventilation device being connected to a corresponding electrical outlet of the motherboard, however, the electrical wire connected to the plug is usually short, so placement of the ventilation device is limited by the range of the wire to nearby the electrical outlet of the motherboard, thereby the ventilation device may not be placed advantageously or conveniently for dissipating the most heat.

What is desired, therefore, is to provide a power supply adapter which can transform a power supply interface of a ventilation device to receive power from another source other than the motherboard or other electrical product.

### SUMMARY OF THE INVENTION

In one preferred embodiment, a power supply adapter is provided to transform a power supply interface of a ventilation device. The ventilation device includes a plug. The power supply adapter includes a main body. The main body includes a mounting element for mounting the ventilation device, a first power supply interface for electrically connecting with the plug of the ventilation device, and a second power supply interface. The second power supply interface is for connecting with an external power supply. The first power supply interface is electrically connected to the second power supply interface.

Other advantages and novel features will become more apparent from the following detailed description when taken in conjunction with the accompanying drawings, in which:

### BRIEF DESCRIPTION OF THE DRAWINGS

FIG. 1 is an exploded, isometric view of a power supply adapter in accordance with a first preferred embodiment of the present invention, together with a fan;

FIG. 2 is an assembled view of FIG. 1;

FIG. 3 is an isometric view of a power supply adapter in accordance with a second preferred embodiment of the present invention;

FIG. 4 is an isometric view of a power supply adapter in accordance with a third preferred embodiment of the present invention;

FIG. 5 is an exploded, isometric view of a power supply adapter in accordance with a fourth preferred embodiment of the present invention, together with a blower;

FIG. 6 is an assembled view of FIG. 5;

FIG. 7 is an isometric view of a power supply adapter in accordance with a fifth preferred embodiment of the present invention; and

FIG. 8 is an isometric view of a power supply adapter in accordance with a sixth preferred embodiment of the present invention.

### DETAILED DESCRIPTION OF THE INVENTION

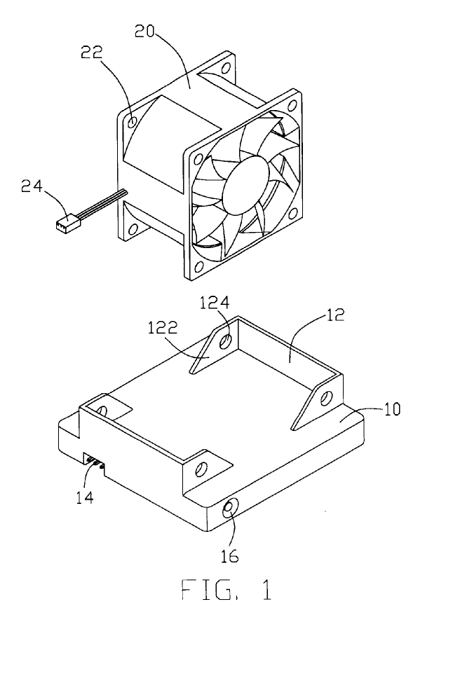

Referring to FIG. 1, a power supply adapter in accordance with a first preferred embodiment of the present invention is provided as an interface to connect a ventilation device such as a fan 20 to a power supply. In this embodiment, the fan 20 includes a pair of aligned mounting holes 22 defined in each of four corners of the fan 20, and a plug 24.

The power supply adapter includes a main body 10. The main body 10 includes a mounting element such as a pair of retaining portions 12 extending up from two opposite edges of the main body 10, a first power supply interface such as an electrical outlet 14 for receiving the plug 24, and a second power supply interface such as a transformer interface 16 for connecting with a transformer.

Each of the retaining portions 12 is generally U-shaped, and includes two parallel arms 122. Each of the arms 122 defines a through hole 124 therein corresponding to the mounting hole 22 of the fan 20. The transformer interface 16 is electrically connected to the electrical outlet 14 (inside of the main body 10, not shown).

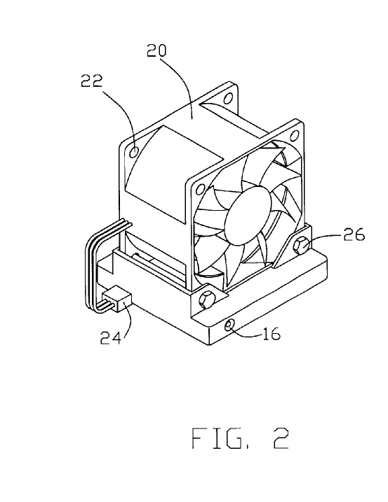

Referring also to FIG. 2, in assembly, the fan 20 is received by the retaining portions 12 and mounted on the main body 10 by known means such as two screws 26 extending through corresponding through holes 124 of the main body 10 and corresponding mounting holes 22 of the fan 20. The plug 24 is electrically connected to the electrical outlet 14. When using the fan 20 to dissipate heat produced by an electrical product such as a motherboard (not shown), the fan 20 can be supplied power via a transformer (not shown) connected to the transformer interface 16 of the main body 10, the transformer also being connected to an external power supply (not shown). Because the fan 20 is supplied power not by the motherboard but by the transformer, it is convenient to situate the fan 20 advantageously for dissipating the most heat.

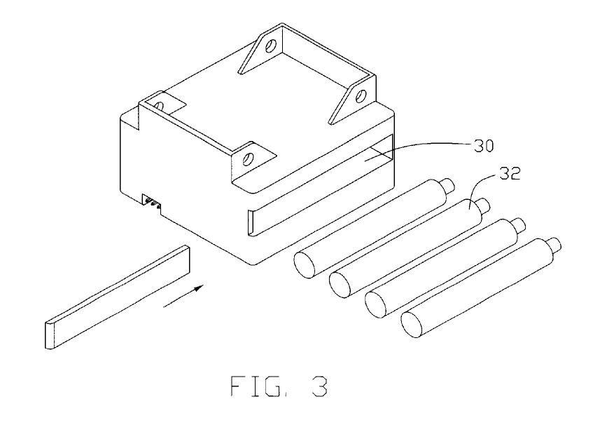

Referring also to FIG. 3, a power supply adapter in accordance with a second preferred embodiment of the present invention is shown. The second preferred embodiment is similar to the first preferred embodiment, except that in place of the transformer interface 16 a battery compartment 30 is provided. In this embodiment, the battery compartment 30 uses four batteries 32, as an example (i.e. external power supply, an amount and type of the batteries 32 can be confirmed according to need), to supply power to the fan 20, thereby the fan 20 can be placed wherever it is most effective for dissipating heat.

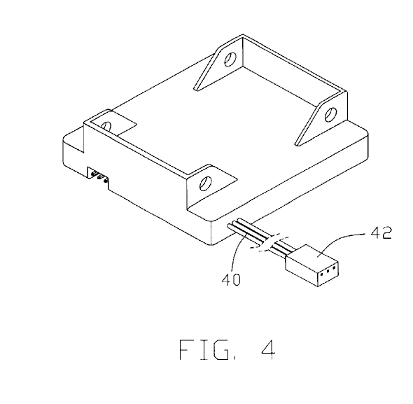

Referring also to FIG. 4, a power supply adapter in accordance with a third preferred embodiment of the present invention is shown. The third preferred embodiment is similar to the first preferred embodiment, except the transformer interface 16 is replaced by an extended electrical wire 40 with a plug 42. A length of the electrical wire 40 can be chosen according to need. When using the fan 20 to dissipate heat generated by an electrical product such as a motherboard (not shown), the plug 24 of the fan 20 is connected to a corresponding electrical outlet of the motherboard. Because the extended electrical wire 40 is chosen to be as long as needed, the fan 20 can be placed wherever it is most effective for dissipating heat.

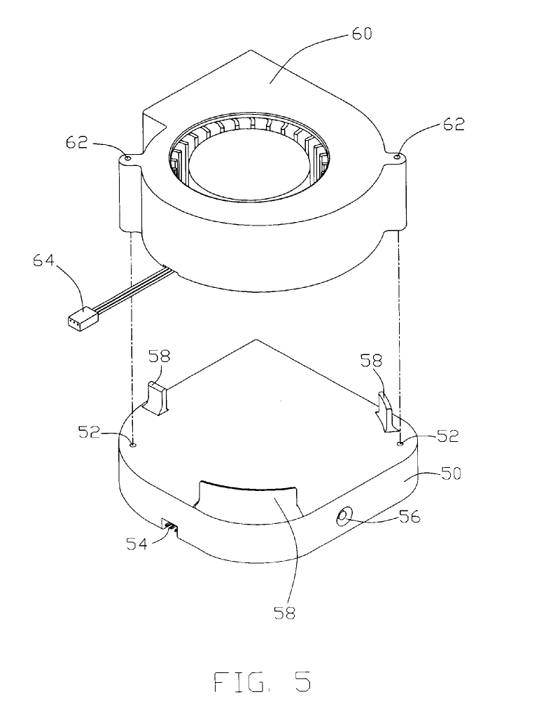

Referring to FIG. 5, a power supply adapter in accordance with a fourth preferred embodiment of the present invention is provided to transform a power supply interface of a ventilation device such as a blower 60. In this embodiment, the blower 60 includes two threaded holes 62 and a plug 64.

The power supply adapter includes a main body 50. The main body 50 includes a mounting element such as two through holes 52 corresponding to the two threaded holes 62 of the blower 60, a first power supply interface such as an electrical outlet 54 for connecting the plug 64, and a second power supply interface such as a transformer interface 56 for connecting a transformer. A plurality of positioning elements 58 is formed extending up from one side of the main body 50 for retaining the blower 60.

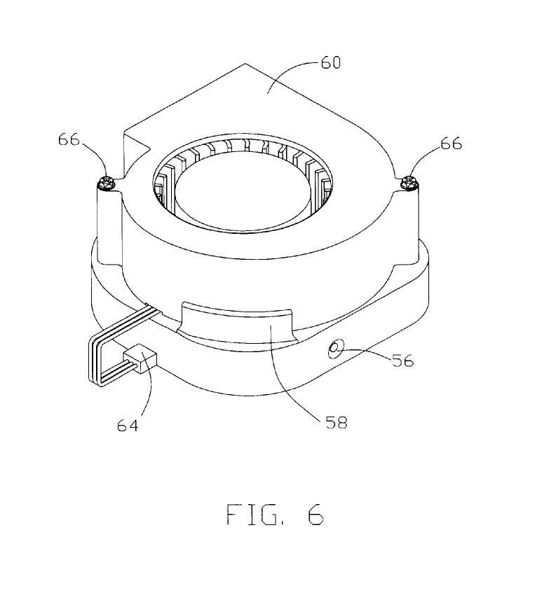

Referring also to FIG. 6, in assembly, the blower 60 is received by the retaining portions 58 and mounted on the main body 50 by known means such as two screws 66 extending through the threaded holes 62 of the blower 60, and into the through holes 52 of the main body 50. The plug 64 is electrically connected to the electrical outlet 54. Like the first preferred embodiment, it is convenient to situate the fan 20 advantageously for dissipating the most heat.

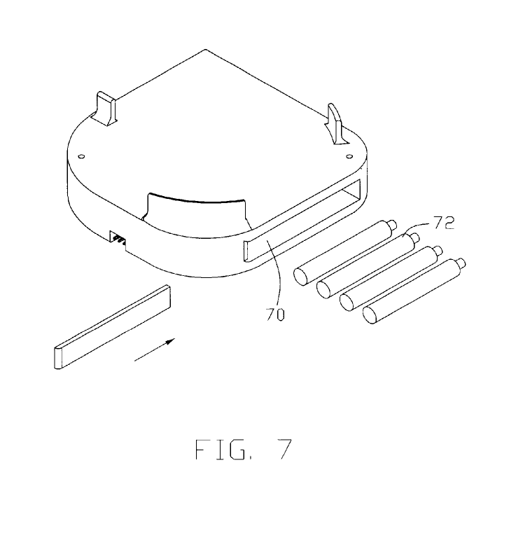

Referring also to FIG. 7, a power supply adapter in accordance with a fifth preferred embodiment of the present invention is shown. The fifth preferred embodiment is similar to the second preferred embodiment, except the blower 60 is provided instead of the fan 20.

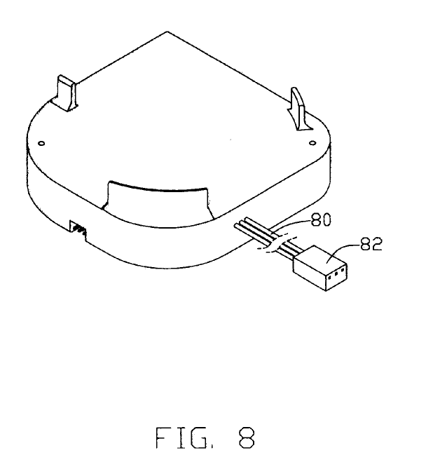

Referring also to FIG. 8, a power supply adapter in accordance with a sixth preferred embodiment of the present invention is shown. The sixth preferred embodiment is similar to the third preferred embodiment, except the blower 60 is provided instead of the fan 20.

It is to be understood, however, that even though numerous characteristics and advantages of the preferred embodiments have been set forth in the foregoing description, together with details of the structures and functions of the embodiments, the disclosure is illustrative only, and changes may be made in detail, especially in matters of shape, size, equivalent material and arrangement of parts within the principles of the invention to the full extent indicated by the broad general meaning of the terms in which the appended claims are expressed.

What is claimed is:

1. A power supply adapter of a ventilation device having a plug, the power supply adapter comprising:
a main body comprising a mounting element for mounting the ventilation device, a first power supply interface for electrically connecting with the plug of the ventilation device, and a second power supply interface for connecting with an external power supply, the first power supply interface electrically connected to the second power supply interface.

2. The power supply adapter as claimed in claim 1, wherein the ventilation device is a fan.

3. The power supply adapter as claimed in claim 2, wherein the mounting element comprises a pair of retaining portions extending up from two opposite edges of the main body, each of the retaining portions includes two parallel arms, each of the arms defines a through hole therein, the through holes corresponding to mounting holes at corners of the fan.

4. The power supply adapter as claimed in claim 1, wherein the ventilation device is a blower.

5. The power supply adapter as claimed in claim 4, wherein the mounting element comprises two through holes defined in the main body, the through holes corresponding to threaded holes of the blower.

6. The power supply adapter as claimed in claim 1, wherein the second power supply interface is a transformer interface.

7. The power supply adapter as claimed in claim 1, wherein the second power supply interface is a battery compartment for receiving batteries therein and supplying power to the ventilation device.

8. The power supply adapter as claimed in claim 1, wherein the second power supply interface is an extended electrical wire with a plug.

9. A ventilation device assembly comprising:
a ventilation device comprising a plug;
a main body mounting the ventilation device thereon;
a first power supply interface on the main body electrically connected to the plug of the ventilation device; and
a second power supply interface on the main body for connecting with an external power supply, the first power supply interface electrically connected to the second power supply interface.

10. The ventilation device assembly as claimed in claim 9, wherein the ventilation device is a fan.

11. The ventilation device assembly as claimed in claim 10, wherein the main body comprises a pair of retaining portions extended up from two opposite edges thereof, each of the retaining portions includes two parallel arms, each of the arms defines a through hole therein, the through holes corresponding to mounting holes at corners of the fan.

12. The ventilation device assembly as claimed in claim 9, wherein the ventilation device is a blower.

13. The ventilation device assembly as claimed in claim 12, wherein the main body comprises two through holes defined therein, the through holes corresponding to threaded holes of the blower.

14. The ventilation device assembly as claimed in claim 9, wherein the second power supply interface is a transformer interface.

15. The ventilation device assembly as claimed in claim 9, wherein the second power supply interface is a battery compartment for receiving batteries therein and supplying power to the ventilation device.

16. The ventilation device assembly as claimed in claim 9, wherein the second power supply interface is an extended electrical wire with a plug.
